(19) United States
(12) Patent Application Publication
(10) Pub. No.: US 2015/0066997 A1
(43) Pub. Date: Mar. 5, 2015

(54) Systems and Methods for Managing Power Plant Component Information

(71) Applicant: General Electric Company, Schenectady, NY (US)

(72) Inventors: Pavan Kumar Singh Thakur, Hyderabad (IN); Rohan Saraswat, Hyderabad (IN); Venkatesh Mani Selvaraj, Hyderabad (IN); Nagesh Laxminarayana Kurella, Hyderabad (IN); Karthikeyan Loganathan, Hyderabad (IN); So Young Kim, San Ramon, CA (US)

(73) Assignee: General Electric Company, Schenectady, NY (US)

(21) Appl. No.: 14/015,318

(22) Filed: Aug. 30, 2013

(51) Int. Cl. G06F 17/30

(52) U.S. Cl. CPC G06F 17/3028; G06F 17/30312
USPC 707/812

(57) ABSTRACT

Certain embodiments herein relate to systems and methods for managing power plant component information. In one embodiment, a system can include at least one memory configured to store computer-executable instructions and at least one control device configured to access the at least one memory and execute the computer-executable instructions. The instructions may be configured to associate an identifier with a component and correlate the identifier with component information stored in a database. The instructions may be configured to output the information to a portable device. In another embodiment of the disclosure, an output of information to a portable device may be specified and updated according to input to the portable device.

### FIELD OF THE DISCLOSURE

Embodiments of the disclosure generally relate to managing information about power plant components and, more particularly, to systems and methods for managing information about power plant components.

### BACKGROUND

Information about components in power plants has become more detailed, specific, and therefore voluminous. Organizing and navigating these large amounts of information can require more than just a robust and efficient database. Information must be readily accessible to a component operator, even if the operator is using a portable device. The mobility of a computing device may not be enough in that the information must be accessible efficiently. In critical situations or to increase operator efficiency, access to component information can be relatively important.

### BRIEF SUMMARY OF THE DISCLOSURE

Some or all of the above needs and/or problems may be addressed by certain embodiments of the disclosure. Certain embodiments may include systems and methods for managing information about a power plant component. According to one embodiment of the disclosure, there is disclosed a system. The system may include at least one memory configured to store computer-executable instructions and at least one control device configured to access the at least one memory and execute the computer-executable instructions. The instructions may be configured to associate a component with a unique identifier and store the identifier in a database. The instructions may correlate information for the component with the identifier and allow access to the information including according to the identifier or the correlation. The instructions may be further configured to output the information to a portable device. According to another embodiment of the disclosure, there is disclosed a method. The method may include assigning a unique identifier to a component, correlating the identifier with information about the component, and storing the identifier and/or the correlation in a database. The method may further include retrieving the information and outputting it to a portable device.

According to another embodiment of the disclosure, there is disclosed a system. The system may include at least one memory configured to store computer-executable instructions and at least one control device configured to access the at least one memory and execute the computer-executable instructions. The instructions may be configured to store component information in a database, retrieve the information, and output the information to a portable device. The instructions may be further configured to display a portion of the information according to input to the portable device. In addition, the instructions may be further configured to output other portions of the information and information about other components, according to input to the portable device.

Other embodiments, systems, methods, aspects, and features of the disclosure will become apparent to those skilled in the art from the following detailed description, the accompanying drawings, and the appended claims.

### BRIEF DESCRIPTION OF THE DRAWINGS

The detailed description is set forth with reference to the accompanying drawings, which are not necessarily drawn to scale. The use of the same reference numbers in different figures indicates similar or identical items.

FIG. 1 illustrates an example system for associating a unique identifier with a component and correlating that with component information in a database, according to an embodiment of the disclosure.

FIG. 2 is a flow diagram of an example method for associating an identifier with a component and outputting component information to a portable device based at least in part on a correlation between the identifier and the information, according to an embodiment of the disclosure.

FIG. 3 is a flow diagram of an example method for outputting component information to a portable device according to input to the portable device, according to an embodiment of the disclosure.

### DETAILED DESCRIPTION

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so this disclosure will satisfy applicable legal requirements.

Certain embodiments disclosed herein relate to managing power plant component information. Accordingly, a system can be provided to associate a component with a unique identifier and to correlate the identifier with component information stored in a database. For example, an operator may use a portable device to recognize the unique identifier and to communicate the identifier to a database in retrieving component information from the database. Based at least upon a correlation between the unique identifier and component information stored in a database, at least a portion of the information can be output to the portable device. Thereafter, the operator may navigate a display of the information for viewing different organized displays of the information. One or more technical effects associated with certain embodiments herein may include, but are not limited to, accessibility to all the information about a component through automatic recognition of an identifier by a portable device and recognition of any component's identifier and access to that component's corresponding information. Furthermore, one or more technical effects associated with certain embodiments can include reducing the number of operator inputs required to display information about multiple portions of the information and about multiple components and power plants.

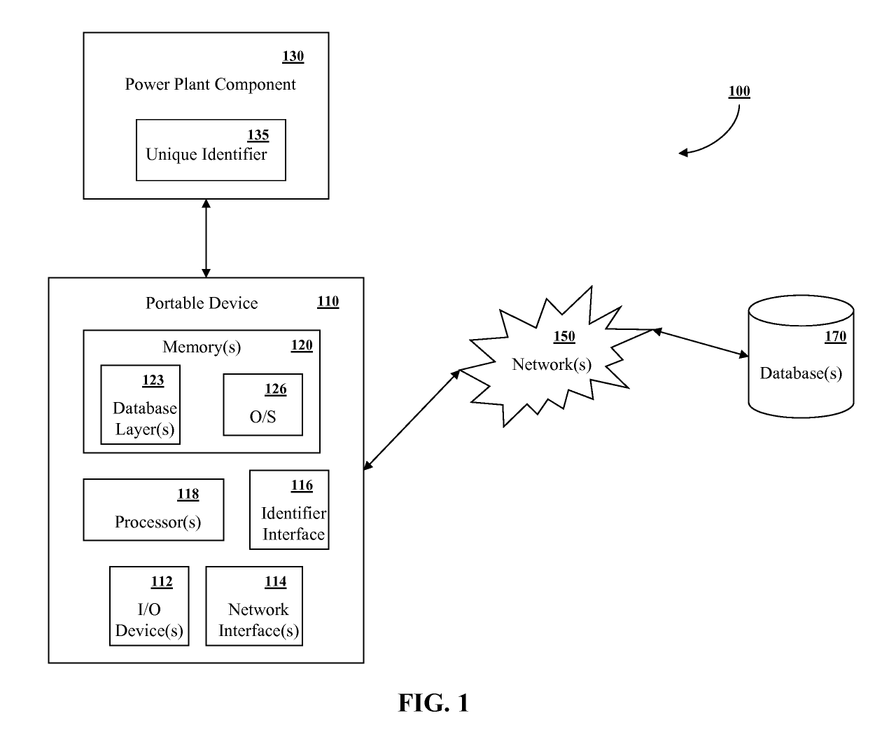

FIG. 1 depicts a block diagram of one example system 100 that facilitates managing power plant component information. According to an embodiment of the disclosure, the system 100 may include a portable device 110 that includes an identifier interface 116. The identifier interface 116 may be configured to recognize a unique identifier 135 of a power plant component 130. The unique identifier 135 may comprise a label associated with the power plant component 130. In one embodiment of the disclosure, a bar code label may be attached to the power plant component 130 and recognized as the unique identifier 135 by the portable device 110 including through use of the identifier interface 116.

With continued reference to FIG. 1, in one embodiment of the disclosure, the portable device 110 may further communicate through a network 150, network interface 114, and database layer 123 to a database 170. The database layer 123 may retrieve information about the power plant component 130 from the database 170. The database layer 123 may further cause a value of the unique identifier 135 to be stored in the database 170. In a further embodiment, the portable device 110 may subsequently use storage of a unique identifier value in the database 170 to more efficiently retrieve information about the power plant component 130 for subsequent database transactions. The portable device 110 may retrieve from the database 170 information specific to the power plant component 130 that is associated with the unique identifier 135. In a further embodiment of the disclosure, the database layer 123 may retrieve from the database 170 information about a different power plant component 130 based at least on a different unique identifier 135 of that different power plant component 130.

The portable device 110 may include any number of suitable computer processing components that may, among other things, recognize a unique identifier 135 detected by the identifier interface 116. Examples of suitable processing devices that may be incorporated into the portable device 110 include, but are not limited to, personal computers, tablet computers, personal digital assistants, mobile phones, application-specific circuits, microcontrollers, minicomputers, other computing devices, and the like. As such, the portable device 110 may include any number of processors 118 that facilitate the execution of computer-readable instructions. By executing computer-readable instructions, the portable device 110 may include or form a special purpose computer or particular machine that facilitates processing of power plant component identification and database communication.

In addition to one or more processor(s) 118, the portable device 110 may include one or more memory devices 120, one or more input/output (“I/O”) devices 112, and/or one or more communications and/or network interfaces 114. The one or more memories 120 may include any suitable memory devices, for example, caches, read-only memory devices, random access memory devices, magnetic storage devices, etc. The one or more memories 120 may store user or other input, data, executable instructions, and/or various program modules utilized by the portable device 110, for example, at least one database layer 123, an operating system (“O/S”) 126, and/or an identifier interface 116. The one or more memories 120 may comprise any suitable data and applications that facilitate the operation of the portable device 110 including, but not limited to, for portable device 110 operation and for communication between the portable device 110 and a power plant component 130, a network 150, and a database 170. The O/S 126 may include executable instructions and/or program modules that facilitate and/or control the general operation of the portable device 110.

Additionally, the O/S 126 may facilitate the execution of other software programs and/or program modules by the processor(s) 118, such as, the identifier interface 116. The identifier interface 116 may be a suitable software module with corresponding hardware capability configured to allow communication with objects outside the portable device 110. For instance, the identifier interface 116 may read a unique identifier 135 associated with a power plant component 130.

According to one embodiment, the portable device 110 may be configured to recognize a unique identifier 135 via the identifier interface 116. For example, upon acquiring information from the power plant component 130, an identifier interface 116 can recognize a unique identifier 135 from the information acquired. In one embodiment, this acquisition may comprise a camera of the portable device 110 to capture an image of at least part of a power plant component 130. A unique identifier 135 may then be disseminated from the image and, for example, converted to a digital value for electronic processing or storage. As another non-limiting example, a unique identifier 135 may comprise a readily available electronic format, such as a barcode, and the barcode may be read by a portable device 110 via the identifier interface 116. In reading the unique identifier 135 from a camera image or barcode reader, the identifier interface 116 may comprise use of optical character recognition (“OCR”) techniques to distinguish the unique identifier 135 apart from additional data. The unique identifier 135 may be used by the portable device 110, and may be stored in memory 120 as well as in the database 170. The portable device 110 may correlate the barcode with information in a database 170 that corresponds to the power plant component 130 associated with the unique identifier 135. The correlation of the unique identifier 135 with corresponding information about the power plant component 130 may further be stored in the database 170 via at least one database layer 123 and/or at least one network interface 114. Upon being stored in one or more memories 120 and/or at least one database 170, the correlation may be used in subsequent acquisitions of either or both of the unique identifier 135 and the component information.

In certain embodiments, the identifier interface 116 may include one or more program modules that facilitate capturing a unique identifier 135 associated with a power plant component 130. For instance, the identifier interface 116 may comprise one or more cameras that detect the unique identifier 135. This detection may comprise disseminating the unique identifier 135 from other information captured by the one or more cameras. Thereafter, a software module of a database layer 123 may be executed and configured to automatically, or in response to some other trigger, transmit the captured unique identifier and any other information associated with the unique identifier to a database 170 via network 150. The database layer 123 may cause the database 170 to store the unique identifier 135, to return information to the portable device 110, or both. In another embodiment, the identifier interface 116 may comprise one or more barcode readers, where at least one software module is able to recognize a barcode, associate the barcode with a power plant component 130, and communicate the barcode to a database 170. The communication between the portable device 110 and the database 170 may comprise storing the barcode in the database 170 and retrieving information about the power plant component 130.

Upon recognizing the unique identifier 135 or receiving information from the database 170, the portable device 110 may cause data to be output via at least one I/O device 112. An operator of the portable device 110 may be able to read the output via the at least one I/O device 112. In a further example, the operator may use the at least one I/O device 112 to read only a portion of the information and to cause the portable device 110 to read a different unique identifier 135. The portable device 110 and its associated data, software modules, and hardware capabilities would then be able to recognize, process, store, and use the unique identifier 135 as described above.

As desired, embodiments of the disclosure may include a system 100 with more or fewer components than are illustrated in FIG. 1. Additionally, certain components of the system 100 may be combined in various embodiments of the disclosure. The system 100 of FIG. 1 is provided by way of example only.

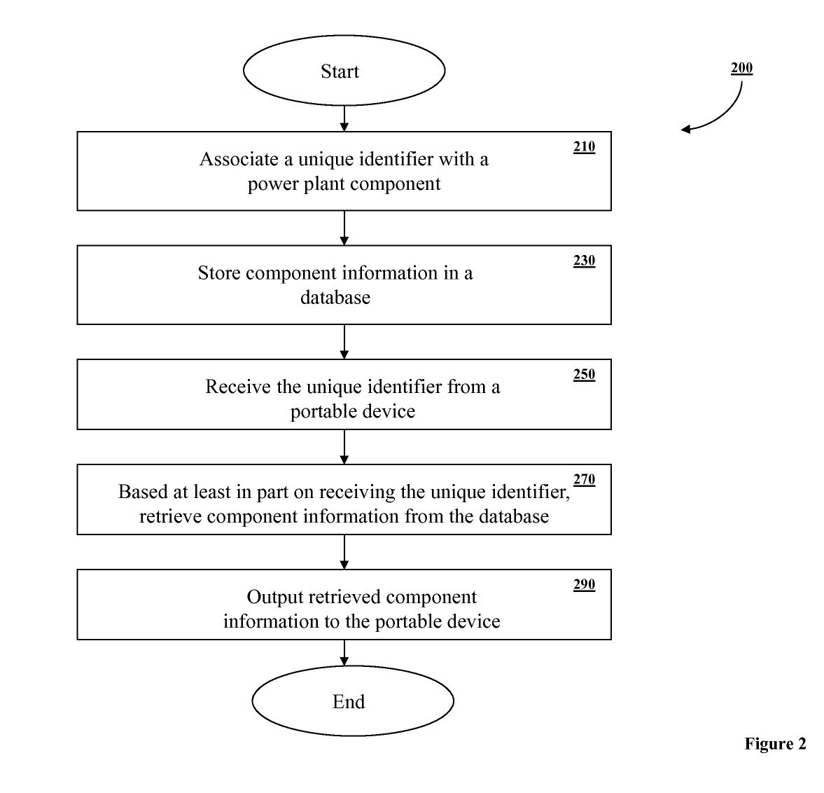

Referring now to FIG. 2, shown is a flow diagram of an example method 200 for managing power plant component information, according to an illustrative embodiment of the disclosure. The method 200 may be utilized in association with various systems, such as the system 100 illustrated in FIG. 1.

The method 200 may begin at block 210. At block 210, a unique identifier, such as 135 in FIG. 1, may be associated with a power plant component 130. In certain embodiments, the unique identifier 135 may be a barcode, and further, the barcode may be attached to the power plant component 130, for example, as a barcode sticker. The barcode sticker may be placed on the power plant component 130, for example, during commission or installation of the component.

Next, at block 230, information about the power plant component 130 may be stored in a database, such as the at least one database 170 of FIG. 1. The database 170 is able to store all the information about the power plant component 130, as well as information about other components, including components in other power plants. Some of the information may comprise parameters and documentation of the power plant component 130. The database 170 may comprise many databases and storage devices and the databases and storage devices may be located across many computer networks, such as the at least one network 150 of FIG. 1.

Next, at block 250, the method 200 comprises receiving the unique identifier 135 from a portable device, such as the portable device 110 of FIG. 1. In certain embodiments, the portable device 110 may comprise a camera to capture an image of the unique identifier 135. The portable device 110 may further comprise at least one software module to parse the unique identifier 135 from the image. The unique identifier 135 may then be processed, used, and stored by the portable device 110. In a further embodiment, the unique identifier 135 may comprise a barcode and the portable device 110 may comprise a barcode reader for recognizing the barcode. The barcode reader may read the barcode and output its value to the method 200. Additionally, recognizing the unique identifier 135 may further comprise using OCR techniques to distinguish the unique identifier 135 from other data.

Next, at block 270, the method 200 may retrieve component information from the database 170. The retrieving may be based at least in part on the receiving of the unique identifier 135 in block 250. The database 170 may be accessible through use of a database layer such as the at least one database layer 123 of FIG. 1, and via network 150 including through use of a network interface such as the at least one network interface 114 of FIG. 1, and the network 170 may comprise any computer network including the internet. The database may comprise information about the power plant component 130 as well as information about other components and other power plants. The method 200 may retrieve all or any portion of this information and the method 200 may repeat this step any number of times.

Next, at block 290, the information retrieved from the database 170, including from block 270, may be output to the portable device 110. The output may be sent to an input/output device (“I/O”) such as the at least one I/0 device 112 of FIG. 1. In one embodiment of the disclosure, the output may comprise a display of the information to a screen of the portable device 110. The screen may further comprise an ability to receive input, including from a human operator, and the display of information to the screen may be changed based at least in part on input received from the operator.

The method 200 of FIG. 2 may optionally end following block 290.

The operations described and shown in the method 200 of FIG. 2 may be carried out or performed in any suitable order as desired in various embodiments of the disclosure. Additionally, in certain embodiments, at least a portion of the operations may be carried out in parallel. Furthermore, in certain embodiments, fewer than or more than the operations described in FIG. 2 may be performed.

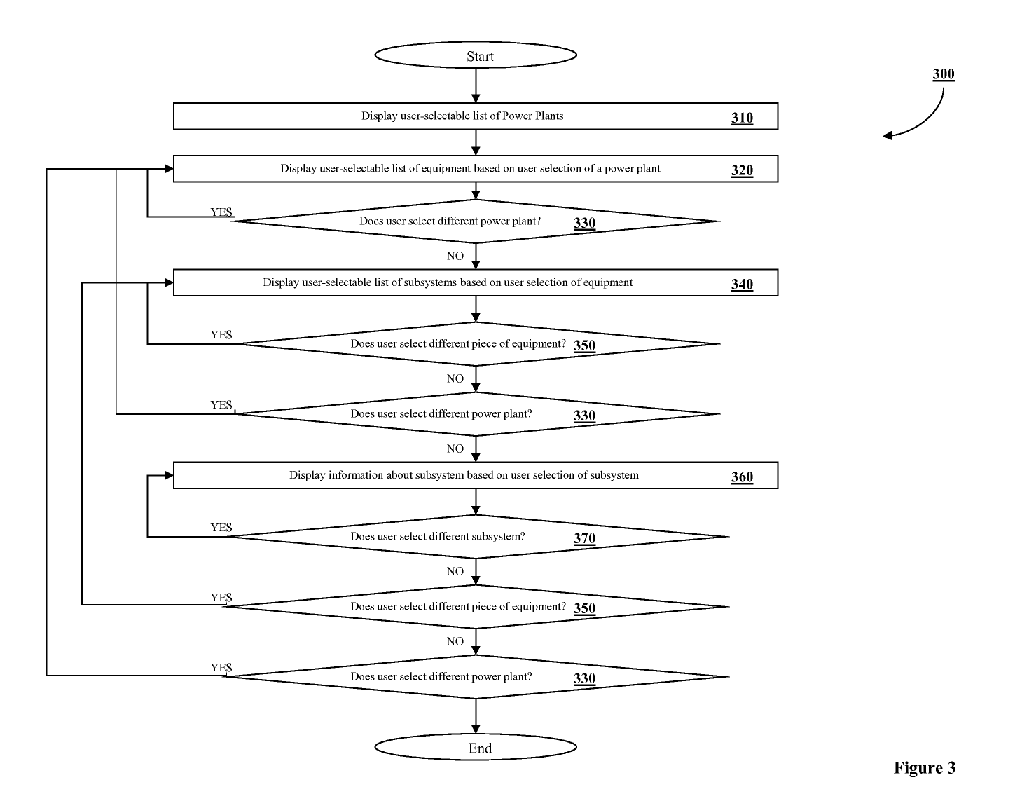

Referring now to FIG. 3, shown is an example method for management and navigation of power plant component information on a portable device, such as the portable device 110 illustrated in FIG. 1. Also, the operations described below may be carried out or performed on any other computing device, as that term is commonly known. The operations may be carried out or performed in any suitable order as desired in various embodiments of the disclosure. Additionally, in certain embodiments, at least a portion of the operations may be carried out in parallel. For example, more than one list may be displayed at a single time. Furthermore, in certain embodiments, fewer than or more than the operations described in FIG. 3 may be performed.

In one embodiment, display of power plant component information may be output to the portable device 110, including after being retrieved from a database, such as the database 170 of FIG. 1. The display may comprise parameters and other information of a power plant component 130, including data used to populate human-machine interface (“HMI”) screens on the portable device 110. In a certain embodiment, an I/O device 112 of the portable device 110 may comprise a touch-sensitive display screen able to receive input from a human operator. The method 300 may change the output of information based at least in part on operator input to the touch-sensitive display screen.

The method 300 may begin at block 310. In one embodiment, a list of power plant components and information about the components may be displayed on the portable device 110. The list may be navigable through operator input to the display screen. In one embodiment of the disclosure, more than a single list may be displayed at a single time. For example, a list of power plants may be displayed 310 in addition to a list of equipment available for the selected power plant 320. In a further embodiment, the list of power plants may be displayed 310 across the top of the screen and the list of equipment for the selected power plant 320 may be displayed immediately beneath the list of power plants 310. Each list displayed on the screen may be accessible by the operator and operator selection of a member of a list may cause the display to show different information and/or lists based at least in part on the operator selection.

Next, at block 330, the operator may select from the list of power plants 310 a different power plant than is currently selected or a first power plant if there is no current selection. Upon receiving operator input for selection of a power plant 330, the method 300 may update the displayed list of equipment 320 according to the operator input to reflect equipment relevant to the selected power plant. In one embodiment, if an operator does not select a power plant for display 330 a list of subsystems may be displayed 340 based at least in part on a selection from the list of equipment by the operator. In another embodiment, the list of subsystems may be displayed 340 based on a default selection from the list of equipment.

Next, at block 350, the operator may select from the displayed list of equipment 320. Upon receiving operator input for selection of equipment 350, the method 300 may update the displayed list of subsystems 340 according to the operator input to reflect subsystems relevant to the selected equipment. In one embodiment, if an operator does not select a power plant for display 330 and the operator does not select equipment for display 350, information about a subsystem may be displayed 360 based at least in part on the currently selected equipment. In another embodiment, the information about a subsystem may be displayed 360 based on a default selection from the list of subsystems.

In one embodiment, at blocks 330, 350, and 370, an operator may select from any of the displayed lists a further list or information about a power plant component. Some lists may be displayed based at least in part on relevance to the operator input or a default selection. An operator may select from a displayed list at any time, and may cause a different display of lists via input to the portable device 110. In this way, the method 300 disclosed herein can be a repeating and/or fractional version of the example flow chart shown in FIG. 3. The disclosure is described above with reference to block and flow diagrams of systems, methods, apparatus, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general purpose computer, a special purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

While the disclosure has been described in connection with what is presently considered to be the most practical and various embodiments, it is to be understood that the disclosure is not to be limited to the disclosed embodiments, but on the contrary, is intended to cover various modifications and equivalent arrangements included within the spirit and scope of the appended claims.

This written description uses examples to disclose the disclosure, including the best mode, and also to enable any person skilled in the art to practice the disclosure, including making and using any devices or systems and performing any incorporated methods. The patentable scope of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system of managing power plant component information, the system comprising:
at least one processor; and
at least one memory storing computer-executable instructions, wherein the at least one processor is operable to access the at least one memory and execute the computer-executable instructions to:
associate a unique identifier with at least one component associated with a power plant;
store the component information in a database, the database accessible by a portable device;
based at least in part on receiving the unique identifier from a portable device, retrieve the component information from the database; and
output the component information to the portable device.

2. The system of claim 1, wherein the association of the unique identifier with at least one component associated with the power plant comprises a camera to capture an image of the unique identifier.

3. The system of claim 2, wherein the computer-executable instructions are further operable to distinguish the unique identifier from other objects in the image captured by the camera.

4. The system of claim 1, wherein the unique identifier comprises a barcode or a machine readable code.

5. The system of claim 1, wherein the computer-executable instructions are further operable to create a mapping between the component information and the unique identifier, and store the mapping in the database.

6. The system of claim 5, wherein the mapping is operable to retrieve the equipment information from the database.

7. The system of claim 1, wherein the computer-executable instructions are further operable to receive user input configuration instructions for display of the component information via the portable device.

8. A method of managing power plant component information, the method comprising:
associating a unique identifier with at least one component associated with a power plant;
storing the component information in a database, the database accessible by a portable device; and
based at least in part on receiving the unique identifier from a portable device:
retrieving the component information from the database; and
outputting the component information to the portable device.

9. The method of claim 8, wherein reading the unique identifier further comprises recording an image of the unique identifier by a camera of the portable device.

10. The method of claim 9, wherein reading the unique identifier further comprises distinguishing the unique identifier from other objects in the image.

11. The method of claim 8, wherein associating the equipment with the unique identifier further comprises assigning a barcode to the equipment.

12. The method of claim 8, further comprising creating a mapping between the equipment information and the unique identifier, and storing the mapping in the database.

13. The method of claim 12, wherein the portable device may use the mapping to retrieve and display the equipment information from the database.

14. The method of claim 8, further comprising configuring by user input a display of the power plant equipment information on the portable device.

15. A system of managing power plant component information, the system comprising:
at least one processor; and
at least one memory storing computer-executable instructions, wherein the at least one processor is operable to access the at least one memory and execute the computer-executable instructions to:
store the component information in a database, the database accessible by a portable device;
retrieve the component information from the database; and
output the component information to the portable device,
wherein the output comprises at least one list of power plant components, at least one list of component subsystems of the power plant selected based at least in part on user input to the at least one list of power plant components, and information associated with at least one subsystem selected based at least in part on user input to the at least one list of component subsystems.

16. The system of claim 15, wherein the computer-executable instructions are further operable to output an expandable and contractible sublist of a component subsystem of the at least one list of component subsystems of the power plant, wherein output of the sublist is based at least in part on user input to the at least one list of component subsystems of the power plant.

17. The system of claim 16, wherein the computer-executable instructions are further operable to output the sublist based at least in part on user input to the at least one list of power plant components.

18. The system of claim 15, wherein the computer-executable instructions are further operable to output at least one list of power plants, the at least one list of power plants navigable through user input.

19. The system of claim 15, wherein the computer-executable instructions are further operable to select the at least one list of component subsystems of the power plant based at least in part on a unique identifier, wherein the unique identifier is associated with a power plant component and stored in the database.

20. The system of claim 15, wherein the computer-executable instructions are further operable to receive a user instruction to configure a display of the output.
